(19) United States
(12) Patent Application Publication
(10) Pub. No.: US 2016/0299859 A1
(43) Pub. Date: Oct. 13, 2016

(54) APPARATUS AND METHOD FOR EXTERNAL ACCESS TO CORE RESOURCES OF A PROCESSOR, SEMICONDUCTOR SYSTEMS DEVELOPMENT TOOL COMPRISING THE APPARATUS, AND COMPUTER PROGRAM PRODUCT AND NON-TRANSITORY COMPUTER-READABLE STORAGE MEDIUM ASSOCIATED WITH THE METHOD

(71) Applicants: Daniel Dumitru Popa, BUCHAREST (RO); ALEXANDRA DRACEA, COMARNIC (RO); DRAGOS MILOIU, BANESTI (RO)

(72) Inventors: Daniel Dumitru Popa, BUCHAREST (RO); ALEXANDRA DRACEA, COMARNIC (RO); DRAGOS MILOIU, BANESTI (RO)

(73) Assignee: Freescale Semiconductor, Inc., Austin, TX (US)

(21) Appl. No.: 15/036,847

(22) PCT Filed: Nov. 22, 2013
(86) PCT No.: PCT/IB2013/060340

§ 371 Date: May 16, 2016

(51) Int. Cl. G06F 13/28; G06F 11/36; G06F 3/0484

(52) U.S. Cl. CPC G06F 13/28; G06F 3/0484; G06F 11/3648

(57) ABSTRACT

There is disclosed an apparatus for external access to core resources (211,212) of a processor (2) comprising a processing core (21), a shared memory (22), and a multiple paths Direct Memory Access, DMA, controller (23). Access to core critical resources can be performed while the core is executing an application program. The proposed apparatus comprises a Manager module (13) which is operable to setup the DMA controller to copy the assigned core resources via allocated DMA channel into a safe memory region. Further, an Observer module (14) is operable to read the transferred data and make the correlation on the host apparatus side. This allows accessing data used by the core via the DMA controller into, e.g., a run-time debugger accessible region.

### FIELD OF THE INVENTION

This invention relates to an apparatus and a method for external access to core resources of a processor, to a semiconductor systems development tool comprising such apparatus, and to a computer program product and a non-transitory computer-readable storage medium associated with the method.

### BACKGROUND OF THE INVENTION

In the past few years, a trend in the semiconductor industry has been leading the Integrated Circuit (IC) manufacturers to develop products, in particular processors or chips of that kind, which are dedicated to very specialized market segments. In order to fulfil the market demands in terms of cost and performance, newest processor families are thus designed to perform only some specific tasks of digital signal processing.

Furthermore, entire low end product families are now upgraded to offer functionalities that in the near past were available in high end products only, while being faster and cheaper. Therefore, the need for enhanced software (SW) capabilities to replace hardware (HW) features is receiving more and more consideration from the design community.

One drawback of this approach, however, is that most of the common hardware resources dedicated to, e.g., system debug and performance characterization, are stripped away from the chips in order to improve cost/performance criteria. Such processor hardware resources used to include, for instance, standard interfaces and chip peripherals to perform trace operations.

In known products, any System-on-Chip (SoC) core resource can be accessed using a debug probe, namely a physical device operable to connect and debug the software embedded in the system. This allows an external host computer program, named a debugger, to be used to test and debug the embedded software when the core is stopped. An external debugger using this approach is configured to implement an algorithm whereby the core is placed in a debug mode and the requested data is read through, e.g., a JTAG (Joint Test Action Group) interface. However, stopping the core, reading data and then resuming core's execution is a slow process which may alter the behaviour of real-time user applications.

Access to the core resources when the core is running is an additional challenge which can be achieved by providing dedicated trace hardware support within the chip that can be expensive in terms of used silicon area, or code instrumentation that can seriously jeopardize the performance. For instance, U.S. Pat. No. 7,080,283 discloses simultaneous real-time trace and debug for multiple processing core systems on a chip, using HW probes when core is halted and a HW trace module when core is running. A trace module is expensive, may have limited capability in terms of configuring what to trace, and it may fail to address the real-time needs since decoding large trace packages takes too long. In addition, the hardware may not support collecting the requested information in the trace buffer. For example, it may not allow collecting the values of Memory Mapped Registers (MMR) or data at any time during the execution because, for example, some trace architectures dump data in a trace buffer only when a change of flow occurs.

U.S. Pat. No. 5,978,902 discloses a debug interface including Operating System (OS) access of a Serial/Parallel debug port using system calls to access memory of a running core. However, the user application has to be linked with a system call library and the calls are executed by the core itself.

Finally, U.S. Pat. No. 8,275,954 discloses using processor Direct Memory Access (DMA) capabilities for copying performance counter data into a system memory, possibly performance counter data from a running core. The main disadvantage of the method disclosed therein, however, is that it uses a dedicated core of the system to manage and perform the DMA transactions.

### SUMMARY OF THE INVENTION

The present invention provides an apparatus and a method for external access to core resources of a processor, a semiconductor systems development tool, a computer program product and a non-transitory computer-readable storage medium as described in the accompanying claims.

Specific embodiments of the invention are set forth in the dependent claims.

These and other aspects of the invention will be apparent from and elucidated with reference to the embodiments described hereinafter.

### BRIEF DESCRIPTION OF THE DRAWINGS

Further details, aspects and embodiments of the invention will be described, by way of example only, with reference to the drawings. Elements in the figures are illustrated for simplicity and clarity and have not necessarily been drawn to scale.

FIG. 1 schematically shows an example of an embodiment of an apparatus for external access to core resources of a processor.

FIG. 2 and FIG. 3 are flow charts illustrating the operation of the apparatus of FIG. 1.

### DETAILED DESCRIPTION OF THE PREFERRED EMBODIMENTS

Unlike the commonly used approach which consists in allowing an external debugger to test and debug an embedded software when the core is stopped and placed in a debug mode so that requested data is read through a debug probe, embodiments provide a solution to access core resources of a processor running in execution mode. This is achieved by using the processor Direct Memory Access (DMA) capabilities. More precisely, the processor DMA engine is used as hardware support by some software modules which are part of the external host debugger.

Embodiments find application for instance, in semiconductor systems development tools, which are intended to embedded software development, configuration, test and debugging.

Referring herein to a processor, what is meant is any System-on-Chip (SoC), for instance a microprocessor (MPU), a microcontroller (MCU), a digital signal processor (DSP), a digital signal controller (DSC), etc., which comprises a central processing unit (CPU) with core resources wherein critical data may need to be accessed from the external.

Although embodiments will be described in the context of debugging of an application program run by the processor core, the proposed solution for accessing critical core resources may be implemented in a wide range of applications. Indeed, core internal data may need to be accessed for any purpose like, for instance, computer program performance evaluation, optimisation, reverse engineering, etc.

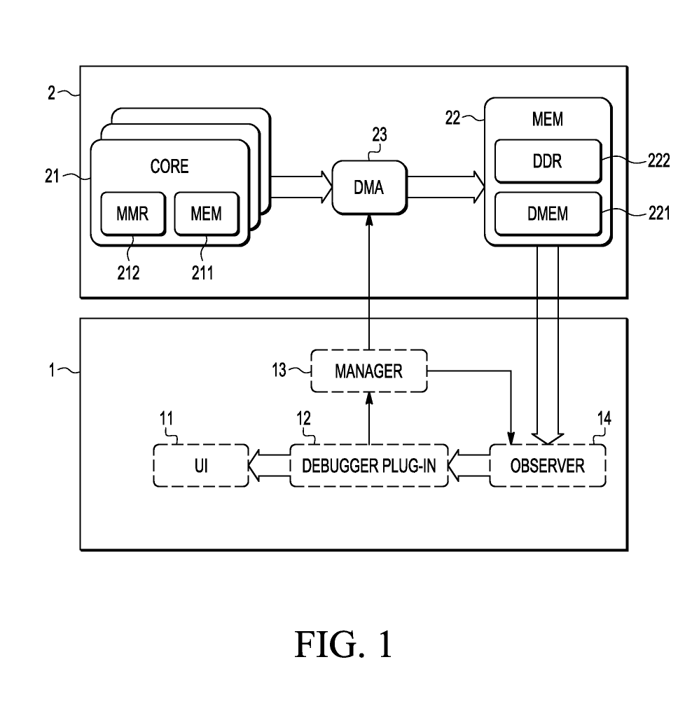

With reference to FIG. 1, a processor 2 comprises at least one processing core 21, namely a CPU that is capable of reading and executing program instructions of a user application. The processor may be a multi-core device, wherein any individual core may be designed to perform some specific tasks of digital signal processing, depending on the application. To that end, the core 21 as shown has internal resources, including executions units and a core memory 211 which is aimed at storing data used and/or produced during execution by the core of the run application program. The core resources may additionally comprise some other, specific memory area 212, for instance Memory Mapped Registers (MMR). MMRs are memory registers mapped to, namely associated with some specific address values, and which may be used to store, e.g., some special-purpose and/or critical data.

The processor 2 further comprises a shared memory 22. This memory may include local data memory (DMEM) 221. Software generally uses DMEM for critical data to take advantage of its zero wait-state latency. The shared memory may additionally comprise double data rate memory (DDR) 222 which allows realizing increased performance over traditional single data rate (SDR) memories.

Finally, processor 2 comprises a DMA controller 23 operable to transfer data between the processing core and the shared memory. Advantageously, this may be a standard DMA controller having multiple DMA channels. The existence of multiple DMA channels, namely of at least two DMA channels, allows the software modules proposed in this innovation not to interfere with the user application program that runs on the chip. It will be appreciated that, nowadays, the use of DMA technology is common for all embedded systems and that, in addition, all DMA controllers have multiple channels. Even more, the trend is to provide DMA controllers with an increased number of channels to be programmed.

As shown further in FIG. 1, the proposed external apparatus 1 for external access to core resources of the processor 2 may be a host debugger.

According to the shown embodiment, such a debugger may comprise a User Interface 11 configured to receive user requests with respect to data stored in the core memory 211 or MMRs 212 of the core 21, and a Controller module 12. Said Controller module 12 may be a debugger plug-in, namely a computer program that can be used to test and debug an application program running in the processor 2, based on data requests made by a user with respect to data stored in the core resources of the processor.

It will be appreciated that the above example of a debugger is purely illustrative, and that the present invention is not intended to be limited by the type of application which require access to the core resources.

The apparatus further comprises a Manager module 13 and an Observer module 14. The Manager 13 and/or the Observer 14 may be implemented in software.

The Debugger plug-in 12 is configured to get a user request and to pass it to the Manager 13.

When this occurs, the Manager 13 is operable to configure the DMA controller 23 to start the transfer of data from the core resources 211,212 to the shared memory 22 of the processor 2, responsive to a user request received through the User Interface 11. Stated otherwise, it manages the external access to the core resource 211,212.

In some embodiments, the Manager 13 may be adapted to search for a free DMA channel resource and reserve it. In order to configure the DMA controller 23, the Manager 13 uses parameters including at least source and destination addresses for the required DMA transfer to be started and performed. When the DMA transfer is completed the Manager 13 notifies the Observer 14 that the requested data is available.

Within the shared memory 22, the transferred data can be stored in a run-time debugger accessible region, referred to as a safe region. This refers to a memory area, i.e. section not being used by the current user application running on the core. This provides the effect that the data transferred via the DMA controller is not overwritten by the application, or vice-versa. This area is accessible by the external JTAG probe when the core is in execution mode. Joint Test Action Group (JTAG) is the common name for the IEEE 1149.1 Standard Test Access Port and Boundary-Scan Architecture.

The Observer module 14 is operable to read the data from the safe region in the shared memory 22 of the processor, responsive to the indication by the Manager 13 that the DMA transfer is completed. At this point, the Observer 14 reads and correlates the data according with specific rules, and sends it to controller 12 for, e.g. visual display through the User Interface 11.

The Controller module 12 is configured to control operation of the User Interface 11, the Manager module 13 and the Observer module 14 while the processor is running in execution mode.

In FIG. 1, the data path is marked with wide arrows while control paths are marked with thin arrows. The requested data is transferred from the core resources (internal memory 211, memory mapped registers 212) through the DMA controller 23 into an accessible region of the shared memory 22 (standard data memory or other, e.g. core private memory). When the transfer is completed the Observer will read the values from the safe region. The Observer will then correlated the data read with the user request and send the value to the debugger. The debugger will then display the requested values to the user.

In some embodiments, the Controller module 12 is further configured to upload data into the core memory 211,212 by controlling the Observer module 14 and the Manager module 13 to perform a write operation through the shared memory 22 and the DMA controller 23.

Thus, the innovation proposes a method that uses the DMA capabilities to transport data in or out (data that are not available while the core is in running mode), into or from a memory region which is external to the core, and which is accessible by the debugger 1 in order to download the information without interaction with the core itself. This mechanism allows parallel core state analysis while the core runs a user application program. This is made without interfering with the program execution.

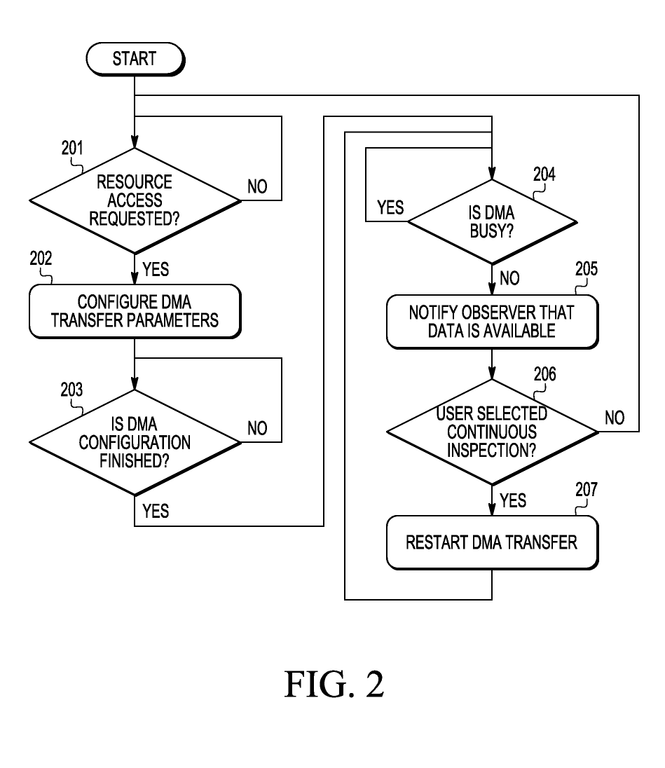

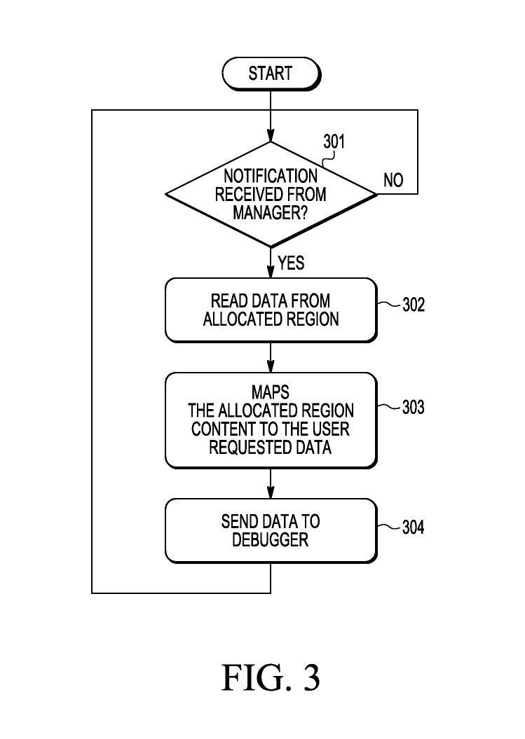

The operation of the device as shown in FIG. 1 will now be described with reference to FIGS. 2 and 3, which are flow charts of steps carried out by the Manager module and by the Observer module, respectively.

Referring first to the flow chart of FIG. 2, the example shown therein comprises the following steps.

At 201, the Manager is waiting for an access request to a core resource to be entered by a user through the User Interface.

If an access is made to a core resource then, at 202, the Manager configures the DMA transfer parameters. This involves setting parameters including at least the source address of the requested data within the core memory, and the destination address of the safe region where the data will be copied in the shared memory 22. A DMA channel to be used can be automatically selected from the available channels, as per the standard operation of the DMA controller. In a variant, a given DMA channel can be specified by the user. Also, in some embodiments, one or more DMA channels may be reserved for the implementation of the method.

In the context of the proposed method, a safe memory region is any memory area within the shared internal memory which is not used by the application software currently running on the debugged system. This safe memory region is accessible to the debugger 1. Since a plurality of requests from the debugger can lead to multiple DMA transfers running simultaneously, or at least to multiple request being handled simultaneously, any suitable memory management algorithm can be used to determine which ranges of safe region in the shared memory are currently used and which are free.

At 203, the Manager waits until the DMA controller is configured. For example, the Manager can poll for a configuration bit in a status register of the DMA controller. Any other suitable scheme can be used to check that the configuration of the DMA controller has been completed, depending on the type of DMA controller used.

After the DMA controller has been configured, the Manager waits at 204 for the DMA transfer to be completed. In one example, the Manager can check the complete status bit of the corresponding channel in a DMA status register, to determine whether the DMA controller is still busy with the DMA transfer.

At 205, when the DMA transfer is completed, the Manager notifies the Observer module 14 that the requested data is available in the safe region of the shared memory 22.

In some embodiments, the Manager can then restart the current DMA transfer, namely proceed with another occurrence of data transfer defined by the same DMA configuration parameters, depending on the user selection. Thus, if the Manager determines at 206 that the user requested, for instance, continuous inspection of the relevant core resources, then at 207 it restarts the DMA transfer and the flow loops to 204. Else, the manager waits for another core resource request to be received from the user.

Turning now to FIG. 3, the Observer module 14 may be configured to operate as follows.

At 301, the Observer is polling for the notification from the Manager module which has been presented above with reference to FIG. 2, at 205. Stated otherwise, the Observed is activated upon receipt of the notification by the Manager the requested data has been made available in the safe region of the shared memory 22 by completion of the DMA transfer.

When this notification is received the Observer operates at 302 to read, from the region of the memory 22 allocated to the DMA transfer, the data which has been transferred therein pursuant to the corresponding configuration of the DMA transfer by the Manager module 13.

In some embodiments, the Observer may then correlate, at 303, the content read from the allocated region and the data the user requested. To that end, the correspondence between the user requested data (MMR or data addresses) and the safe region addresses can be saved by the debugger, for instance before configuring the DMA controller. The aim is to check that the read data maps with the requested data.

Having thus checked that the read data and the user request map, the Observer sends the read data to the Controller module at 304. In other words, the user requested data is passed to debugger, e.g. for display to the user through the User Interface 11.

In some embodiments, the Controller module 12 may be further configured to return the read data to a user through the User Interface 11.

In a variant, the Controller module 12 may be configured to process the read data and to return a feedback to a user through the User Interface 11 based on the processed data. The Controller module 12 may be a debugger program configured to process the read data according to a debugging scheme without interfering with the processor core execution of an application program under debug.

The described innovation thus proposes an efficient solution to access critical core resources while the core is executing a program. This method allows accessing, e.g. mirroring or tunnelling, the data used by the core via the DMA controller into memory region accessible by, e.g. a run-time debugger. This access scheme does not require special hardware support within the processor, since advantage is taken of the presence in all modern processor of an existing DMA unit with multiple paths.

Further advantages of the proposed solution over the prior art identified in the introduction include the following:
the solution allows access to core resources of System-on-Chip (SoC) deprived from dedicated hardware support;
core resources can be accessed while the core is running in execution mode, i.e. is executing a user application, for example a software under debugging;
the core is involved only in the initialization phase and therefore no constraints are imposed to the user application being executed by the accessed core;
while the innovation can be used on multi-core SoCs that are using a DMA engine, no other core needs to be used for accessing the running core resources, since the DMA transaction is initiated by an external debugger which ultimate goal is to display debug information with respect to the application software running on the core;
the DMA transaction management is handled by an external debugger with minimal intrusion into the debugged system because the DMA configuration is made by an external debugger;
no HW specific support such as Trace funnel, nor any additional libraries/code that links with the application is required, since only the standard multi-channel DMA controller is used; and,
the core resources which can be accessed is not limited to certain memory mapped registers or data ranges.

An operating system (OS) is the software that manages the sharing of the resources of a computer and provides programmers with an interface used to access those resources. An operating system processes system data and user input, and responds by allocating and managing tasks and internal system resources as a service to users and programs of the system.

The invention may also be implemented in a computer program product for running on a computer system, at least including code portions for performing steps of a method according to the invention when run on a programmable apparatus, such as a computer system or enabling a programmable apparatus to perform functions of a device or system according to the invention. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system. The computer program may be provided on a data carrier, such as a CD-rom or diskette, stored with data loadable in a memory of a computer system, the data representing the computer program. The data carrier may further be a data connection, such as a telephone cable or a wireless connection.

In the foregoing specification, the invention has been described with reference to specific examples of embodiments of the invention. It will, however, be evident that various modifications and changes may be made therein without departing from the broader scope of the invention as set forth in the appended claims.

Because the apparatus implementing the present invention is, for the most part, composed of electronic components and circuits known to those skilled in the art, circuit details will not be explained in any greater extent than that considered necessary as illustrated above, for the understanding and appreciation of the underlying concepts of the present invention and in order not to obfuscate or distract from the teachings of the present invention.

The term “program,” as used herein, is defined as a sequence of instructions designed for execution on a computer system. A program, or computer program, may include a subroutine, a function, a procedure, an object method, an object implementation, an executable application, an applet, a servlet, a source code, an object code, a shared library/dynamic load library and/or other sequence of instructions designed for execution on a computer system.

Some of the above embodiments, as applicable, may be implemented using a variety of different information processing systems. For example, although FIG. 1 and the discussion thereof describe an exemplary data processing architecture, this exemplary architecture is presented merely to provide a useful reference in discussing various aspects of the invention. Of course, the description of the architecture has been simplified for purposes of discussion, and it is just one of many different types of appropriate architectures that may be used in accordance with the invention. Those skilled in the art will recognize that the boundaries between logic blocks are merely illustrative and that alternative embodiments may merge logic blocks or circuit elements or impose an alternate decomposition of functionality upon various logic blocks or circuit elements.

Thus, it is to be understood that the architecture depicted herein is merely exemplary, and that in fact many other architectures can be implemented which achieve the same functionality. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the functionality of the above described operations merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

All or some of the software described herein may be received elements of apparatus 1, for example, from computer readable media such as memory or other media on other computer systems. Such computer readable media may be permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc.; and data transmission media including computer networks, point-to-point telecommunication equipment, and carrier wave transmission media, just to name a few.

In one embodiment, the apparatus 1 is part of a computer system such as a personal computer system. Other embodiments may include different types of computer systems. Computer systems are information handling systems which can be designed to give independent computing power to one or more users. Computer systems may be found in many forms including but not limited to mainframes, minicomputers, servers, workstations, personal computers, notepads, personal digital assistants, electronic games, automotive and other embedded systems, cell phones and various other wireless devices. A typical computer system includes at least one processing unit, associated memory and a number of input/output (I/O) devices.

A computer system processes information according to a program and produces resultant output information via I/O devices. A program is a list of instructions such as a particular application program and/or an operating system. A computer program is typically stored internally on computer readable storage medium or transmitted to the computer system via a computer readable transmission medium. A computer process typically includes an executing (running) program or portion of a program, current program values and state information, and the resources used by the operating system to manage the execution of the process. A parent process may spawn other, child processes to help perform the overall functionality of the parent process. Because the parent process specifically spawns the child processes to perform a portion of the overall functionality of the parent process, the functions performed by child processes (and grandchild processes, etc.) may sometimes be described as being performed by the parent process.

Also, the invention is not limited to physical devices or units implemented in non-programmable hardware but can also be applied in programmable devices or units able to perform the desired device functions by operating in accordance with suitable program code. Furthermore, the devices may be physically distributed over a number of apparatuses, while functionally operating as a single device. For example,

[symbol]

Also, devices functionally forming separate devices may be integrated in a single physical device.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements The mere fact that certain measures are recited in mutually different claims does not indicate that a combination of these measures cannot be used to advantage.

1. An apparatus external access to core resources of a processor comprising a processing core, a shared memory, and a multiple paths Direct Memory Access, DMA, controller operable to transfer data between the processing core and the shared memory, the device comprising:
a User Interface configured to receive user requests with respect to data stored in the core resources of the processor;
a Manager module operable to configure the DMA controller with parameters to start the transfer of data from the core resources to the shared memory of the processor, responsive to a user request received through the User Interface;
an Observer module operable to read the data from the shared memory of the processor, responsive to an indication by the Manager module that the data transfer is completed; and
a Controller module configured to control operation of the User Interface, the Manager module and the Observer module while the processor is running in execution mode.

2. The apparatus of claim 1, wherein the core resources comprise at least one of an internal core memory and Memory Mapped Registers.

3. The apparatus of claim 1, wherein the Observer module is configured to correlate the read data and the user request, and to pass the read data to the Controller module.

4. The apparatus of claim 3, wherein the Controller module is further configured to return the read data to a user through the User Interface.

5. The device of claim 3, wherein the Controller module is further configured to process the read data and to return a feedback to a user through the User Interface based on the processed data.

6. The apparatus of claim 5, wherein the Controller module is a debugger program configured to process the read data according to a debugging scheme without interfering with the processor core execution of an application program under debug.

7. The apparatus of claim 1, wherein at least one of the Manager module and the Observer module is a software component.

8. The apparatus of claim 1, wherein the Controller module is further configured to upload data into the core resources by controlling the Observer module and the Manager module to perform a write operation through the shared memory and the DMA controller.

9. A semiconductor systems development tool comprising an apparatus for external access to core resources of a processor according to claim 1.

10. A method of external access to core resources of a processor comprising a processing core, a shared memory, and a multiple paths Direct Memory Access, DMA, controller operable to transfer data between the processing core and the shared memory, the method comprising, while the processor is running in execution mode:
receiving a user request with respect to data stored in the core resources of the processor;
configuring the DMA controller with parameters to start the transfer of data from the core resources to the shared memory of the processor, responsive to the user request;
reading the data from the shared memory of the processor, responsive to an indication that the data transfer is completed.

11. The method of claim 10, further comprising correlating the read data and the user request.

12. The method of claim 10, further comprising returning the read data to a user.

13. The method of claim 10, further comprising processing the read data and returning a feedback to a user through the User Interface based on the processed data.

14. The method of claim 13, further comprising processing the read data according to a debugging scheme without interfering with the processor core execution of an application program under debug.

15. A computer program product comprising one or more stored sequences of instructions that are accessible to a processor and which, when executed by the processor, cause the processor to carry out the steps of claim 10.

16. A non-transitory computer-readable storage medium, with computer-readable instructions stored therein for execution by a processor to perform the method of claim 10.
